(19) United States
(12) Patent Application Publication
(10) Pub. No.: US 2025/0259496 A1
(43) Pub. Date: Aug. 14, 2025

(54) SYSTEMS AND METHODS FOR FRESH PRODUCE PRESERVATION AND SMART SHOPPING SOLUTIONS FOR SUSTAINABLE LIVING

(71) Applicants: Elizabeth Moran, Mason, OH (US); Christina Sturgeon, San Diego, CA (US); Grace Reiter, Perrysburg, OH (US); Mary Hintze, Phoenix, AZ (US); Andrew Deros, Tempe, AZ (US); Grant Lesley, Tempe, AZ (US)

(72) Inventors: Elizabeth Moran, Mason, OH (US); Christina Sturgeon, San Diego, CA (US); Grace Reiter, Perrysburg, OH (US); Mary Hintze, Phoenix, AZ (US); Andrew Deros, Tempe, AZ (US); Grant Lesley, Tempe, AZ (US)

(73) Assignee: Arizona Board of Regents on Behalf of Arizona State University, Tempe, AZ (US)

(21) Appl. No.: 19/049,773

(22) Filed: Feb. 10, 2025

Related U.S. Application Data
(60) Provisional application No. 63/551,250, filed on Feb. 8, 2024.

(51) Int. Cl. G07F 9/00; G06Q 10/087; G06Q 20/32; G06Q 30/0601; G07F 9/10

(52) U.S. Cl. CPC G07F 9/001; G06Q 10/087; G06Q 20/3278; G06Q 30/0633; G07F 9/105

(57) ABSTRACT

A fresh produce management system enables customers to acquire single servings of fresh produce while incorporating a food waste prevention app to help inform consumers on how to reduce food waste in their own homes. The storage of the food in the vending machine enhances produce shelf life and maintains food quality. The app itself tells customers when their food is expiring and gives personal recipe recommendations based on consumers' past shopping behaviors.

### CROSS-REFERENCE TO RELATED APPLICATIONS

This is a non-provisional application that claims benefit to U.S. Provisional Application Ser. No. 63/551,250, filed on Feb. 8, 2024, which is herein incorporated by reference in its entirety.

FIELD

The present disclosure generally relates to consumer sustainability systems, and in particular, to a system and associated method for a sustainability-focused fresh produce management system that integrates a mobile application with a produce vending machine.

### BACKGROUND

The rise in global food waste and its detrimental environmental impact has sparked a growing awareness of the need for sustainable solutions. This awareness has pushed researchers and innovators to explore ways to mitigate food waste throughout the supply chain, including post-harvest. Currently, some problems with conventional produce purchase and management methods include excessive single-use packaging, excessive quantities of produce being sold as a unit, and inaccessibility of produce suppliers to pedestrians.

Inaccessibility of produce suppliers to pedestrians particularly requires consumers to set aside time to drive to large grocery stores or pay for grocery delivery, which often causes them to either buy fewer produce items than they need or to over-buy produce items in bulk out of convenience. Some consumers may even be forced to forgo healthier food choices due to inaccessibility.

Further, many consumers have trouble managing their food inventories leading to spoilage and inefficiency, thereby contributing to the global food waste problem.

It is with these observations in mind, among others, that various aspects of the present disclosure were conceived and developed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is an illustration showing a produce management system including a produce vending machine that integrates with an application that can run on a user device of a user;

FIG. 1B is a simplified block diagram showing components and functionalities of the produce management system of FIG. 1A;

FIG. 1C is an illustration showing an actuation arm positioned within one embodiment of the produce vending machine of FIG. 1A with the produce containers removed;

FIG. 1D is an illustration showing a produce container having a grated surface and positioned along an arm of the actuation system of FIG. 1C;

FIGS. 2A-2G are a series of illustrations showing a walkthrough process of a user purchasing a produce item using a produce management system;

FIGS. 3A-3F are a series of photographs showing sequential operation of a “forklift-based” embodiment of the actuation system of a produce management system;

FIG. 4 is a photograph showing one embodiment of a produce container of a produce management system in-situ;

FIG. 5 is an illustration showing a “crane-based” embodiment of the actuation system of a produce management system;

FIGS. 6A-6H are a series of images showing various example user interfaces of a mobile application of a produce management system;

FIG. 7A is a first sequence diagram showing an example interaction between a user, a user device, a server device, and a produce vending machine of a produce management system;

FIG. 7B is a second sequence diagram showing an example interaction between a user, a user device, a server device, and a produce vending machine of a produce management system; and

FIG. 8 is a simplified diagram showing an example computing system for implementation of a produce management system.

Corresponding reference characters indicate corresponding elements among the view of the drawings. The headings used in the figures do not limit the scope of the claims.

### DETAILED DESCRIPTION

A system and associated methods for a produce management system are disclosed herein. The produce management system enables customers to acquire individual servings of fresh produce through a produce vending machine. The produce management system incorporates a food waste prevention app that can interface with the produce vending machine to help inform consumers on managing their food inventory and reducing food waste in their own homes. The produce vending machine includes features that enhance produce shelf life and maintain food quality. The app itself keeps track of produce inventory held by a customer, informs customers when their food may be expiring, and provides personal recipe recommendations based on consumers' past shopping behaviors and their produce inventory.

Fresh Produce Preservation: The system combines innovative food preservation technologies with individual serving sizes. This allows for increased storage time and maintenance of food quality, ensuring that users have access to fresh produce for longer periods.

Proactive Expiration Notifications: An integrated mobile application tracks user purchases and sends timely notifications when the purchased produce is nearing its expiration date. This proactive feature helps individuals plan their meals effectively, reducing food waste and encouraging responsible consumption.

Personalized Recipe Suggestions: The mobile application goes beyond standard notifications by offering personalized recipe suggestions based on customers' purchase history. This feature promotes healthy eating habits, encourages customers to utilize the purchased produce efficiently, and eliminates the need for excess or unplanned food purchases.

Sustainable Convenience: By providing a walkable location resembling a vending machine or small grocery store, the systems outlined herein offer accessibility and convenience to users. It eliminates or otherwise reduces the need for extensive packaging and long-distance transportation, promoting sustainability in food sourcing and reducing the carbon footprint associated with traditional grocery shopping.

Integration of Technology and Consumer Behavior Insights: The combination of food preservation technologies, the mobile application, and insights into consumer behavior creates a holistic solution. By leveraging these elements, the systems outlined herein optimize the shopping experience, encourage mindful consumption, and foster a more sustainable approach to food.

### SUMMARY

In one aspect, the produce management system includes: a produce vending machine having an outer protective structure including a retrieval door and a produce container that stores a produce item; and an actuation mechanism in communication with a computing device. The computing device can include a processor and a memory, the memory including instructions executable by the processor to: access selection data indicative of selection of the produce item from a user; and apply, based on the selection data, an actuating input to the actuation mechanism that causes the actuation mechanism to actuate the produce item to a retrieval position that is associated with the retrieval door.

In some embodiments, the actuation mechanism can have a carousel arrangement that rotates responsive to the actuating input, rotating the produce container from an arbitrary position to the retrieval position. In other embodiments, the actuation mechanism can include an arm element that picks up the produce container from an arbitrary position and carries the produce container to the retrieval position. Further, in some embodiments, the actuation mechanism can include a claw element that picks up a selected produce item from the produce container and carries the selected produce item to the retrieval position.

The produce management system can further include an environment control system including one or more temperature and/or humidity sensors, one or more temperature and/or humidity modifier device(s), and one or more methane sensors. The environment control system can measure an environmental condition of the produce container and apply based on the environmental condition, a modifying input to the one or more temperature and/or humidity modifier device(s) that modify a temperature and/or humidity of the produce container. In some aspects, the environment control system can include one or more sterilization elements and/or one or more pest control elements.

The produce management system can further include a monitoring system including one or more scales associated with the produce container and/or a retrieval tray. The monitoring system can measure a pre-selection weight and a post-selection weight of the produce container and/or retrieval tray and can calculate a weight displacement based on the pre-selection weight and the post-selection weight. The memory of the computing device can further include instructions executable by the processor of the computing device to send a communication to a server device associated with the produce management system that includes information about the weight displacement. In some examples, the server device can apply a charge to a user payment account based on the weight displacement.

In some aspects, the monitoring system can include one or more cameras associated with the produce container and/or a retrieval tray (associated with the retrieval door). The monitoring system can capture one or more images showing manual selection of the produce item from the produce container and/or the retrieval tray. In some examples, the monitoring system can further apply an object recognition process and/or an action recognition process to the one or more images and identify a tampering action from a user based on the one or more images and the object recognition process and/or the action recognition process.

In some examples, the produce management system can further include an interfacing device in communication with the computing device. The interfacing device can be operable for accessing selection data from a user and identifying a payment account associated with the user. The interfacing device can optionally communicate with a user device of the user which can supply one or more of the selection data and information about the payment account associated with the user.

In some examples, the produce management system can include a server device in association with the computing device. The server device can be operable for facilitating communication between the computing device and a payment account associated with the user. The server device can also be operable for recording information about produce purchases completed by the user.

The server device can be operable for communicating with a user device of the user. In such examples, the user device can supply selection data and/or information about a payment account associated with the user to the server device. The server device can communicate the information about produce purchases completed by the user to the user device. The server device can also provide services targeted at helping the user manage their personal produce inventory. These services can include communicating information about an estimated freshness of the produce item to the user device based on a date of purchase of the produce item (and/or date that the produce item was stocked within the produce vending machine). Other services can include communicating information about a recipe using the produce item to the user device based on the estimated freshness of the produce item and the information about produce purchases completed by the user (e.g., other produce items purchased by the user).

In some aspects, the techniques described herein relate to a system, including: a produce vending machine including: an outer protective structure having a retrieval door and a produce item captured within the outer protective structure; and an actuation mechanism configured to retrieve the produce item responsive to a selection input from a user and position the produce item proximate the retrieval door; and a server device including a first processor in communication with a first memory, the first memory including instructions executable by the first processor to: record, at a data storage device associated with the server device, information about the produce item with respect to a user account associated with the user; and communicate, over a network, the information to a user device of the user.

In some aspects, the techniques described herein relate to a system, the user device including a second processor in communication with a second memory, the second memory including instructions executable by the second processor to: capture the selection input from the user indicating the produce item; and communicate, over a communication channel, the selection input to the server device or a computing device of the produce vending machine.

In some aspects, the techniques described herein relate to a system, the first memory of the server device including instructions executable by the first processor to: generate a user produce inventory associated with the user account, the user produce inventory including the information about the produce item and an estimated expiration date of the produce item; and communicate, to the user device over the network, information about the user produce inventory including the estimated expiration date of the produce item.

In some aspects, the techniques described herein relate to a system, the first memory of the server device including instructions executable by the first processor to: communicate, to the user device and over the network, one or more recipes that include the produce item based on the user produce inventory.

In some aspects, the techniques described herein relate to a system, the first memory of the server device including instructions executable by the first processor to: display the one or more recipes based on the estimated expiration date of the produce item.

In some aspects, the techniques described herein relate to a system, the first memory of the server device including instructions executable by the first processor to: access a meal plan input from the user device that includes a selected recipe of the one or more recipes; and generate a shopping list for display at the user device based on the selected recipe.

In some aspects, the techniques described herein relate to a system, the user device including a second processor in communication with a second memory, the second memory including instructions executable by the second processor to: access receipt data indicative of a grocery receipt associated with the user; and communicate, to the server device over the network, information about one or more additional produce items identifiable within the receipt data for inclusion within a user produce inventory associated with the user account.

In some aspects, the techniques described herein relate to a system, the user device including a second processor in communication with a second memory, the second memory including instructions executable by the second processor to: generate a reminder notification based on an estimated expiration date of the produce item relative to a current date.

In some aspects, the techniques described herein relate to a system, the produce vending machine including a computing device having a third processor in communication with a third memory, the third memory including instructions executable by the third processor to: access the selection input indicating the produce item; and apply, based on the selection input, an actuating signal to the actuation mechanism that retrieves the produce item and positions the produce item proximate the retrieval door.

In some aspects, the techniques described herein relate to a system, the produce vending machine including a near-field communication device in communication with the computing device, and the third memory including instructions executable by the third processor to: access the selection input indicating the produce item from the user device through the near-field communication device proximate the user device.

In some aspects, the techniques described herein relate to a system, the produce vending machine including a near-field communication device in communication with the computing device, and the third memory including instructions executable by the third processor to: capture payment information from a user payment device through the near-field communication device proximate the user payment device.

In some aspects, the techniques described herein relate to a system, the first memory of the server device including instructions executable by the first processor to: record the selection input from the user device with respect to the produce vending machine; and communicate the selection input to a computing device of the produce vending machine.

In some aspects, the techniques described herein relate to a system, the first memory of the server device further including instructions executable by the first processor to: apply a charge to a payment account associated with the user account based on the selection input.

In some aspects, the techniques described herein relate to a system, the produce vending machine having a computing device including a third processor in communication with a third memory, the third memory including instructions executable by the third processor to: calculate a weight displacement value based on a pre-selection weight and a post-selection weight of a produce container associated with the produce item; and communicate information about the weight displacement value to the server device over the network, the server device being operable to apply a charge to a user payment account based on the weight displacement value.

In some aspects, the techniques described herein relate to a system, the produce vending machine having an environment control system in communication with a computing device including a third processor in communication with a third memory, the third memory including instructions executable by the third processor to: measure, by one or more sensors of the environment control system, one or more environmental condition values indicative of an environmental condition of an interior of the produce vending machine; and apply a modifying input to an environmental control device based on the one or more environmental condition values.

In some aspects, the techniques described herein relate to a system, the actuation mechanism of the produce vending machine being operable to actuate a produce container capturing the produce item from a storage position to a retrieval position responsive to an actuating signal.

In some aspects, the techniques described herein relate to a system, the actuation mechanism of the produce vending machine having a claw element that carries the produce item from a storage position to a retrieval position responsive to an actuating signal.

In some aspects, the techniques described herein relate to a system, the produce vending machine having an environment control system including one or more sterilization elements and/or one or more pest control elements.

In some aspects, the techniques described herein relate to a system, the produce vending machine including a produce container having a grated surface that supports the produce item captured therein to circulate air below the produce item.

In some aspects, the techniques described herein relate to a system, the produce vending machine including a growing tray.

### Produce Management System

The present disclosure outlines a system and associated

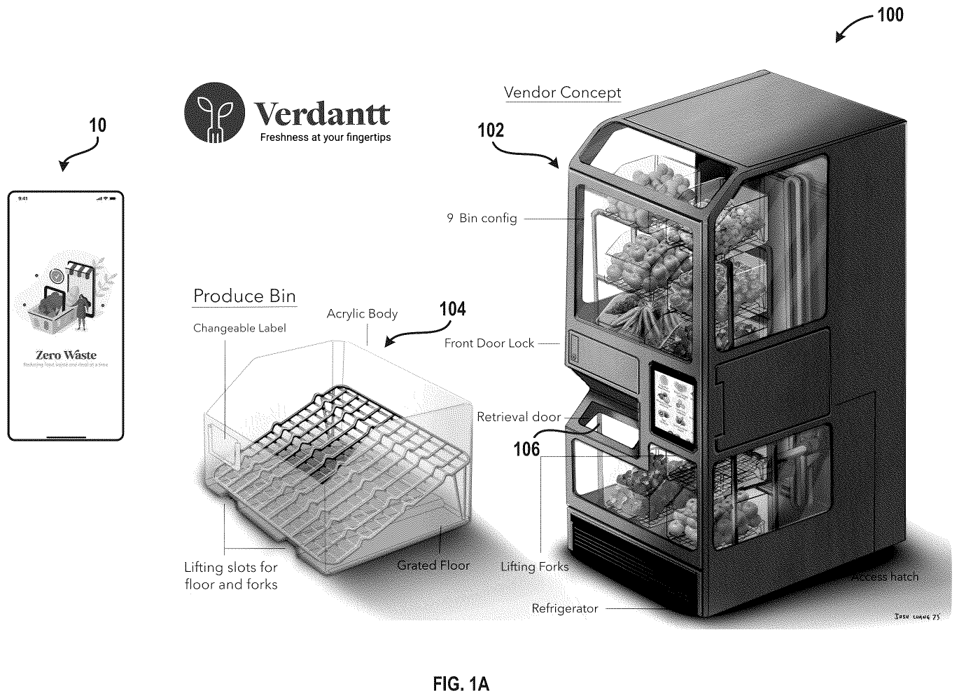

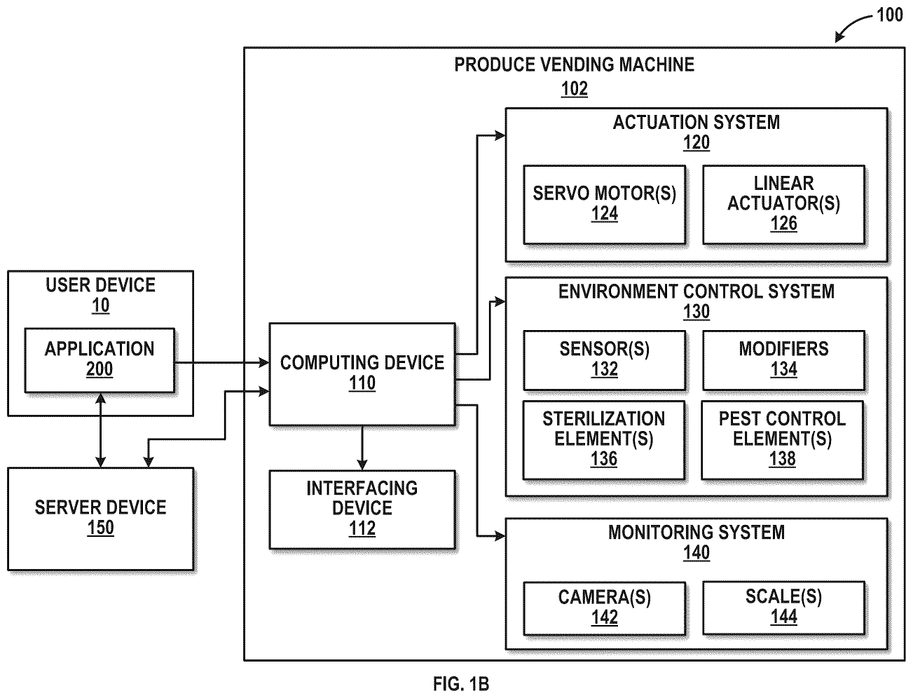

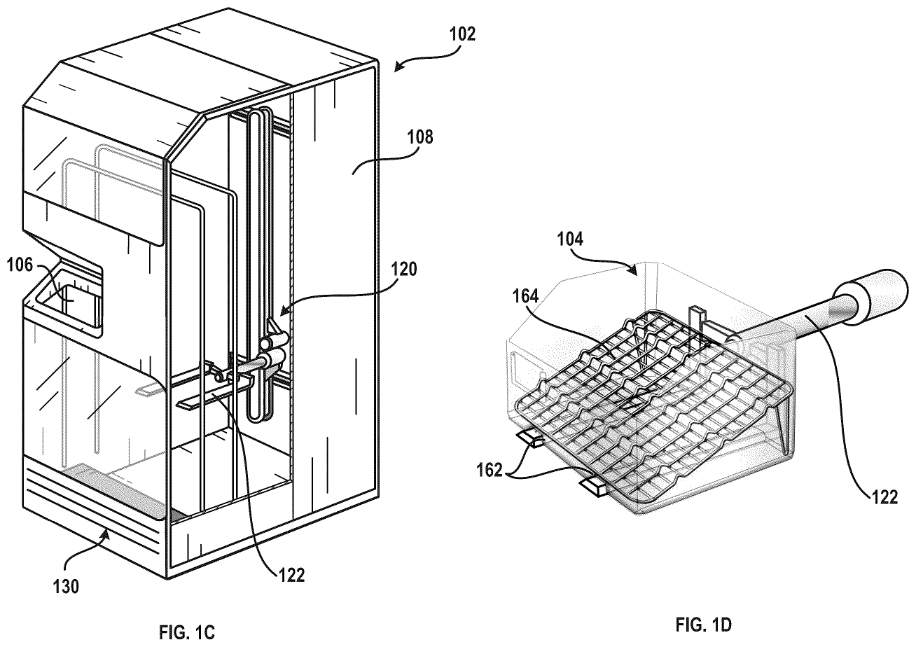

methods for a produce management system 100. FIGS. 1A-1D show example illustrations of one embodiment of the produce management system 100. The produce management system 100 can include a produce vending machine 102 that stores fresh produce for purchase by a user. The user may interact with the produce vending machine 102 through an interfacing device 112 of the produce vending machine 102 (which may be in the form of a touch-screen or other suitable device for displaying information to the user and receiving inputs), or may alternatively interact with the produce vending machine 102 in a “touchless” manner through an application 200 which may run on a user device 10 of the user.

In the example of FIGS. 1A and 1C, the produce vending machine 102 can include an outer protective structure 108 which may include windows for viewing fresh produce stored inside for purchase. The outer protective structure can include a retrieval door 106 which may be positioned at a convenient height for a user while maintaining ADA compliance. The outer protective structure can include locks and access hatches for locking the retrieval door 106 to prevent theft while allowing authorized personnel to open the outer protective structure to stock or perform maintenance on the produce vending machine 102. FIG. 1C shows interior components of an example embodiment of the produce vending machine 102 with the produce containers removed. In FIG. 1C, an actuation system 120 includes an arm element 122 which can lift up a produce container and move the produce container from a storage position to a retrieval position near the retrieval door 106. The produce vending machine 102 can also include an environment control system 130 which can include a refrigerator, air circulation and purification elements, and the like.

FIG. 1D shows a produce container 104 of the produce vending machine 102 which can include a body. In some examples, the body of the produce container 104 can include slots 162 or indentations along a bottom surface of the produce container 104 to provide engagement points for an actuation mechanism of the produce vending machine 102. As shown, the produce container 104 can include a grated surface 164 for produce items to rest on while allowing air to circulate below produce items for freshness preservation.

FIG. 1B shows a simplified block diagram of one embodiment of the produce management system 100. As shown, the produce vending machine 102 can include a computing device 110 which can communicate with various other components of the produce vending machine 102. The produce vending machine 102 can include an actuation system 120 which activates various motors (e.g., servo motor(s) 124 and linear actuator(s) 126) based on signals from the computing device 110 for picking up produce items and delivering the produce items to the retrieval door 106. As discussed in greater detail herein, the actuation system 120 can, in some examples, pick up a produce container 104 having produce items selected by the user and deliver the produce container 104 to the retrieval door 106 where a user may select one or more produce items for purchase. Once the user has completed selection, the actuation system 120 can return the produce container 104 to a designated location within the produce vending machine 102. Other embodiments of the actuation system 120 can include, for example, crane-based actuators such as gantries and claw devices for selecting individual produce items for delivery to the user at the retrieval door 106; the actuation system 120 may alternatively include a carousel device that rotates a selected produce container 104 towards the retrieval door 106.

As further shown, the produce vending machine 102 can include an environment control system 130 for preserving freshness that may communicate with the computing device 110. The environment control system 130 may include one or more temperature or humidity sensor(s) 132 that measure temperature and humidity within the produce vending machine 102, and may measure temperature and humidity within individual produce containers 104. In addition, the environment control system 130 can include methane sensors and other air quality monitoring sensors. The environment control system 130 may also include one or more temperature or humidity modifier device(s) 134 that maintain specified environmental conditions within the produce vending machine 102, and may be applied to individual produce containers 104 (as different produce items may require different conditions for optimal preservation). In some examples, the one or more temperature or humidity modifier device(s) 134 can integrate with a water system for spraying produce when required.

In some examples, the environment control system 130 can include sterilization element(s) 136 such as UV lights to reduce the likelihood of food-borne illness and spoilage from bacteria and mold growth. Further, the environment control system 130 may also include pest control element(s) 138 to eliminate pests that may be present on produce items (such as those that originate from the harvest location of the produce items or that may otherwise ingress into the produce vending machine 102).

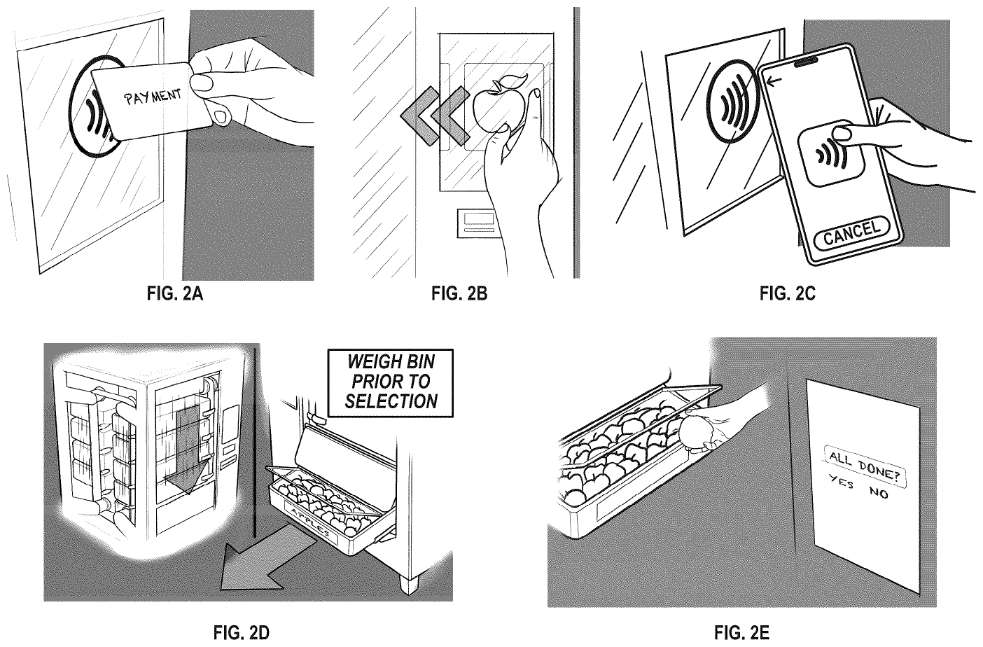

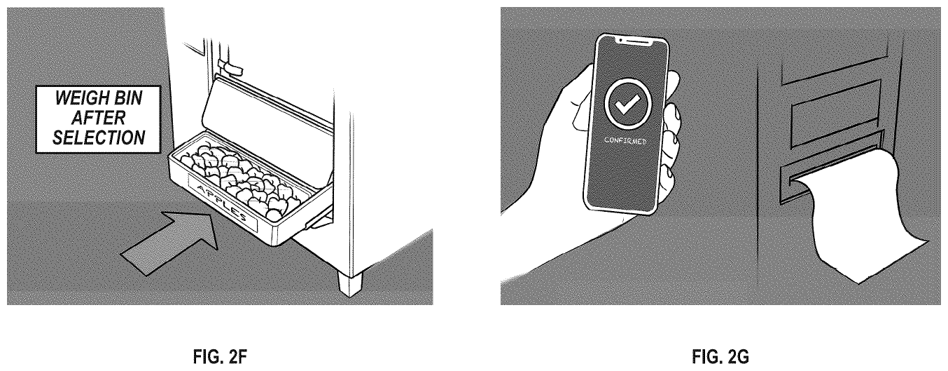

In a further aspect, the produce vending machine 102 can include a monitoring system 140 which may be employed for calculating a bill, and also for theft or tampering deterrent. For example, the monitoring system 140 can include camera(s) 142 and other sensors that detect user actions. Importantly, the monitoring system 140 can include one or more scale(s) 144 which may aid in calculating a weight displacement before and after a user picks up a produce item for purchase (e.g., a produce container 104 weighs 4 lbs. before a user picks up 2 apples totaling 0.7 lbs., after which the produce container 104 weighs 3.3 lbs., the user may be charged at least in part by weight of produce taken). In some examples, the scales 144 may be coupled along the arm element 122 of the actuation system or may line the container 104 to detect changes in weight of produce items captured within the container 104. Further, the cameras 142 of the monitoring system 140 may communicate with the computing device 110, which may employ object-recognition and/or action-recognition software to deter users from theft by unscrupulously swapping produce objects with other similarly-weighted objects. The cameras 142 of the monitoring system 140 may also be employed for food hygiene monitoring to deter users from deliberately tampering with produce or picking up an object with their hands and subsequently returning it. FIGS. 2A-2G are a series of illustrations showing a general process for produce purchase using one embodiment of the produce management system 100. In FIG. 2A, a user approaches the produce vending machine 102 and interacts with a payment processing sensor of the produce vending machine 102, which can communicate with the computing device 110 (FIG. 1B) of the produce vending machine 102 for payment. Interaction with the payment processing sensor may initiate other processes of the produce vending machine 102 to allow the user to select and retrieve produce items for purchase. Alternatively, a user may use a user device 10 running application 200 to interact with the produce vending machine 102 without need for a bank card or cash, where application 200 has access to payment information.

As shown in FIG. 2B, a user may interact with the interfacing device 112 (which may be the user device 10 running application 200) to select a produce item for purchase. In some examples, such as the alternative example of FIG. 2C, the user may communicate item selection to the produce vending machine 102 by the user device 10, e.g., through a near-field communication (NFC) channel or through another modality such as but not limited to: Wi-Fi, Bluetooth, 5G, LTE, or presenting a Quick-Response (QR) code to a camera associated with the interfacing device 112.

Upon selection, the interfacing device 112 signals the computing device 110 to activate the actuation system 120 which can deliver the produce item towards the retrieval door 106, as shown in FIG. 2D. The actuation system 120, which may be located along a back center column of the produce vending machine 102, moves upwards in a smooth motion. While the example in FIG. 2D shows a carousel-based actuation system, note that other types of actuation systems are contemplated and described in further detail herein. Once the produce item is delivered to the retrieval door 106, the user may retrieve the produce item for purchase. In some examples, the produce item may be stored within a produce container (e.g., produce container 104) for which the computing device 110 may maintain an inventory and storage location (e.g., a designated spot for the produce container, which may also have an identifier readable by the computing device 110). The produce container 104 may have a lid that opens upon delivery to the retrieval door 106 so that the user may pick up the produce item of their choice. Further, the produce vending machine 102 may activate one or more scales to weigh the produce container prior to selection by the user (e.g., to obtain a pre-selection weight needed for calculation of a weight displacement value which can be used for billing).

In some examples, to facilitate smooth movement of the produce containers 104 from their storage positions to the dispensing point, the produce vending machine 102 can be equipped with a train track-like system. The produce containers 104 can be placed on small trolleys that run along the tracks. The tracks align when the platform is raised, allowing the designated container to slide onto the platform for dispensing.

Other container dispensing mechanisms which are contemplated include:
Pull System: The container is gently pulled onto the platform by a motorized mechanism, ensuring smooth movement and avoiding damage to the produce.
Forklift System or Alternative Elevator-like Systems: In some vending machine models, a forklift-like mechanism (as in FIGS. 1A, 1C and 1D) or alternative elevator system (similar to “carousel” system as in FIGS. 2A-2G) gently lifts the container onto the platform from below.
Drawer System: A drawer-style mechanism slides out from the vending machine, carrying the chosen container directly to the front for easy retrieval.
Belt System: A conveyor belt transports the selected container from its storage position to the front of the machine, where it is dispensed for the customer. A platform can act as a conveyor track that extends from the back to the front of the machine.
Crane System: An actuating arm in the form of a “crane”, “claw”, or “scoop” may pick up individual produce items and carry the produce items to the retrieval door.

FIG. 2E shows the user picking up a produce item of their choice, and also shows the interfacing device 112 communicating with the user to ask if they would like to make any further purchases. FIG. 2F shows closure and retraction of the produce container 104 into the produce vending machine 102 once the user has completed their selection. Following selection by the user, the produce vending machine 102 may activate one or more scales to weigh the produce container (e.g., to obtain a post-selection weight needed for calculation of a weight displacement value which can be used for billing). FIG. 2G shows completion of a transaction which may include printing a receipt and/or providing notification of the purchase at the user device 10 running the application 200.

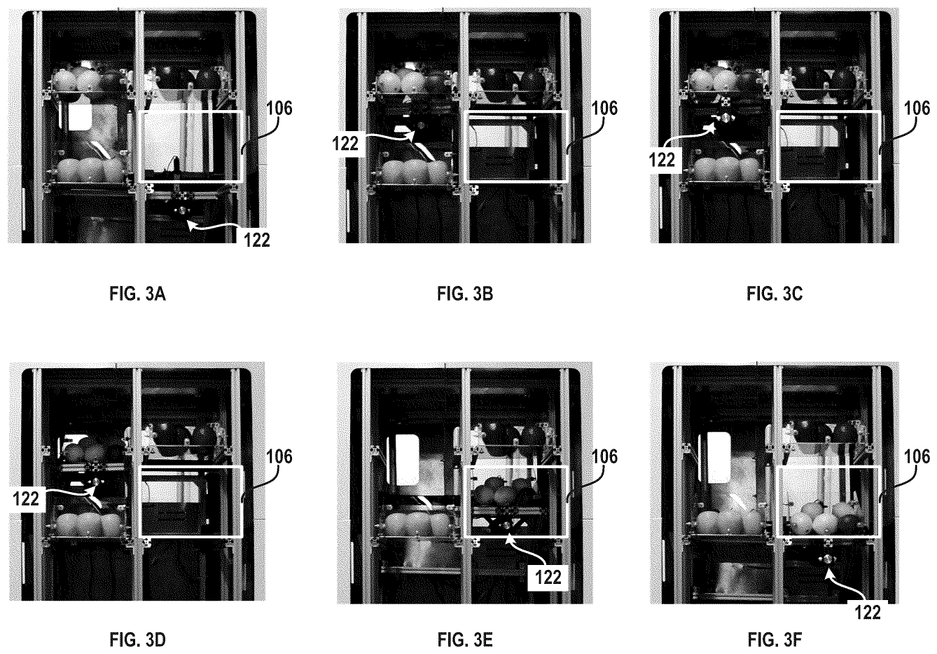

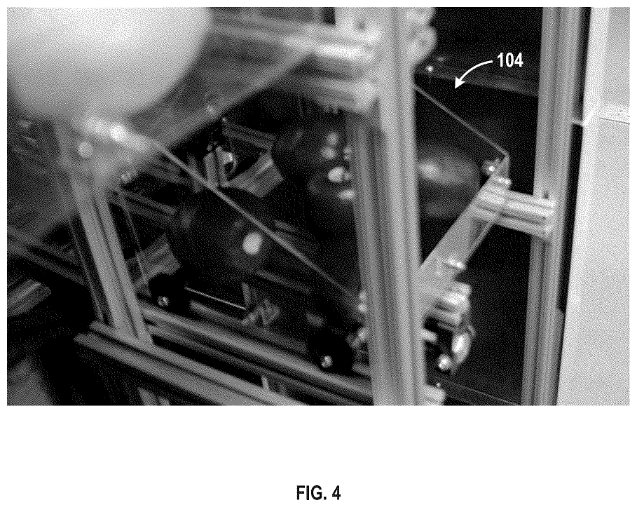

FIGS. 3A-3F show operation of an example embodiment of the actuation system 120 of the produce vending machine 102. While the illustration in FIGS. 2A-2G shows a carousel-based actuation system, the actuation system 120 shown in FIGS. 3A-3F can be described as a “forklift-based” actuation system having an arm element 122. With additional reference to FIG. 1B, the actuation system 120 can include various motors including one or more servo motor(s) 124 and one or more linear actuator(s) 126. The one or more servo motor(s) 124 can be in operative association with supporting elements including one or more belts that allow actuation of an arm element 122 to a selected location within the produce vending machine 102 that can correspond with a produce container. In the examples of FIGS. 3A-3F, the arm element 122 can include a “forklift” element operable for supporting a bottom of a produce container.

In FIGS. 3A and 3B, upon selection of a produce item by the user, the computing device 110 provides actuating inputs to the actuation system 120 that cause the actuation system 120 to move the arm element 122 within the produce vending machine 102 to a location behind a selected produce container 104. Each servo motor 124 of the one or more servo motor(s) 124, in operative association with the one or more belts, can actuate the arm element 122 horizontally along an X axis or vertically along a Y axis. In the example of FIGS. 3A and 3B, the actuation system 120 moves the arm element 122 vertically along the Y axis, then horizontally along the X axis, positioned behind the selected produce container 104.

As shown in FIG. 3C, the computing device 110 provides actuating inputs to the actuation system 120 that cause the linear actuator 126 of the actuation system 120 to move the arm element 122 forward along a Z axis such that the forklift element of the arm element 122 engages the selected produce container 104 (and may be positioned directly underneath the selected produce container 104). In some examples, the servo motor(s) 124 can then gently lift the selected produce container 104 by the forklift element.

As further shown in FIG. 3D and 3E, the computing device 110 provides actuating inputs to the actuation system 120 that cause the linear actuator 126 of the actuation system 120 to move the arm element 122 backward along the Z axis, causing the forklift element to pull the selected produce container 104 away from a track that it previously occupied. The servo motor(s) 124 and linear actuator 126 can then collectively move the selected produce container 104 onto a track associated with the retrieval door 106 as shown in FIG. 3F.

FIG. 4 is a photograph showing a produce container 104 resting on a track within the produce vending machine 102.

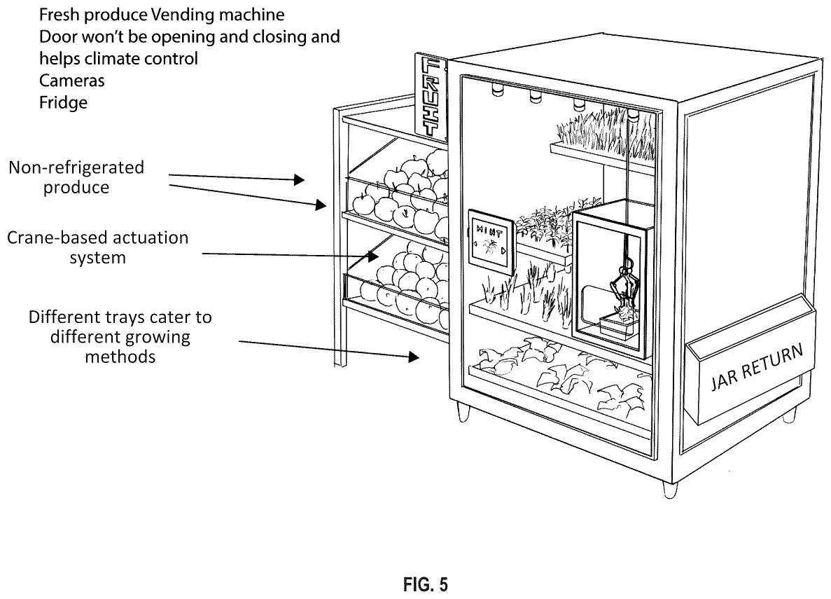

FIG. 5 is a conceptual drawing showing an alternative “crane-based” embodiment of the produce vending machine 102. In addition, the produce vending machine 102 in FIG. 5 is also shown having growing trays for certain types of produce, such as herbs and leafy greens. In such examples, the environment control system 130 can include hydroponic or aeroponic components that maintain proper growing conditions for produce in growing trays. In examples where the produce vending machine 102 uses hydroponic or aeroponic methods for growing, the environment control system 130 can include, e.g., a controller device in communication with pumps, timers, temperature sensors, a water reservoir, pH and nutrient balancing elements, lights, fans, etc. Further, in the example of FIG. 5, the produce vending machine 102 can also include sections that are kept at different conditions, such as a non-refrigerated section for storing produce that is best left at room temperature (e.g., tomatoes). The produce vending machine 102 may also stock servings of produce such as berries in reusable jars which may be returned at a “jar return” box. Users who return jars may be provided with discounts or money back; in such an example, the monitoring system of the produce vending machine 102 may lock the “jar return” box to prevent individuals from throwing trash and other undesirable items into the jar return box, and may also inspect items placed in the jar return box to verify whether a user has actually returned jars if they claim to have done so. The jar return box may also include sterilization elements such as UV lights and/or an antiseptic soaking/rinsing solution to disinfect returned jars.

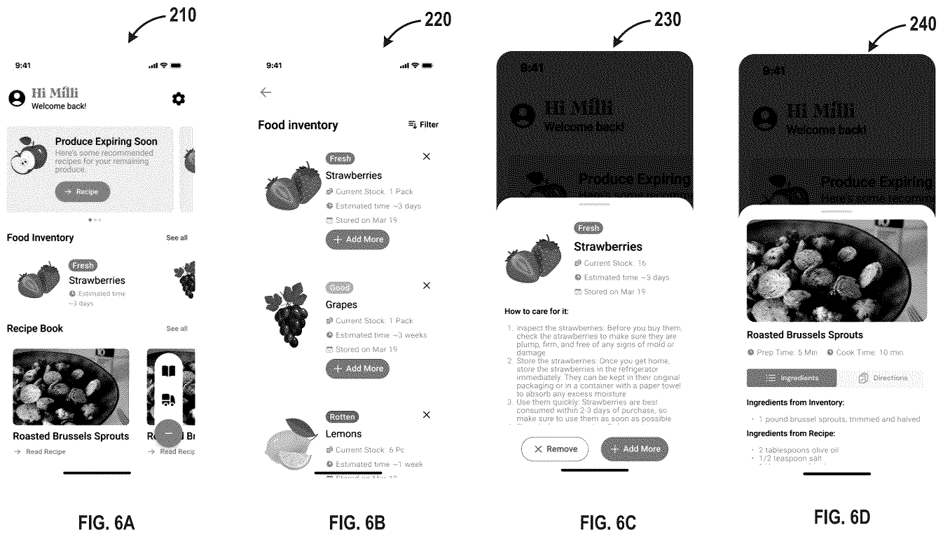

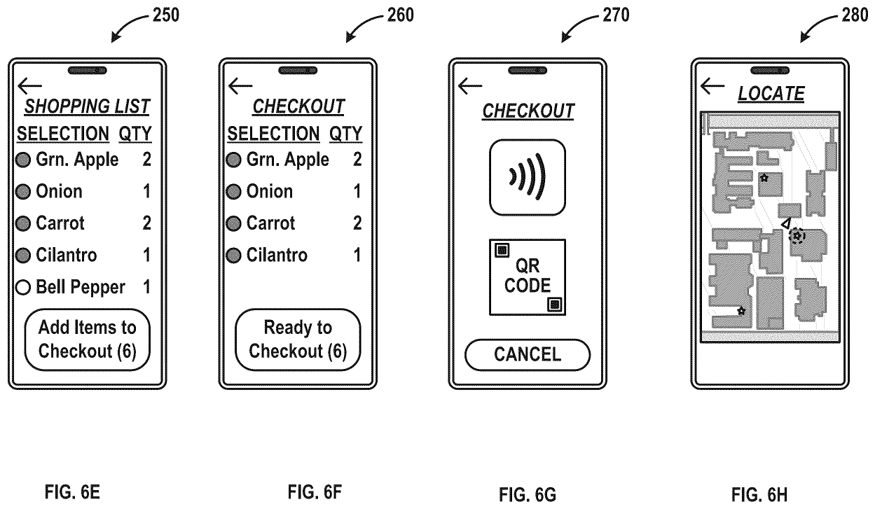

In a further aspect, the produce management system 100 can include the application 200 which may include instructions for execution by a processor of the user device 10. The user device 10 (and the computing device 110 of the produce vending machine 102) may communicate with a server device 150 (FIG. 1B) which can maintain services for management of the produce vending machine 102 and also for the benefit of the user through the application 200. FIGS. 6A-6D show screenshots of an example user interface of the application 200. Note that application functionalities may be distributed between server device 150 and user device 10.

In particular, services provided by the application 200 can include recording purchases of produce by the user from the produce vending machine 102 to aid the user in personal food inventory management and overall food waste reduction. Importantly, the application 200 can: record, at a data storage device associated with the server device 150, information about the produce item with respect to a user account associated with the user; and generate (e.g., at the server device 150) a user food inventory associated with the user account, the user food inventory including the information about the produce item and an estimated expiration date of the produce item. This can extend to displaying an estimate of how “fresh” a previously-purchased produce item may be, based on time/date of stock and/or purchase, and in line with food research and safety guidelines. For example, the application 200 may keep track of: a) when a particular batch of produce was placed into the produce vending machine 102; and b) when a produce item from that batch was purchased by the user.

The application 200 may also keep track of inventory and estimated freshness of produce items acquired by a user through other means, such as through purchase from a grocery or other food source. Such information may be manually entered by the user or entered by scanning receipts by a camera of the user device 10. In some aspects, the application 200 may integrate with nutrition apps and/or grocery apps maintained by grocers and/or grocery delivery services to access receipt data indicative of a grocery receipt associated with the user and communicate, to the server device 150 and over a network, information about one or more additional produce items identifiable within the receipt data for inclusion within the user food inventory associated with the user account.

By tracking purchases, the application 200 notifies users in advance when their purchased produce is approaching its expiration date. This proactive feature enables users to effectively plan their meals and reduce food waste, contributing to a more sustainable lifestyle. Moreover, the application 200 goes beyond simple notifications by providing users with personalized suggestions for healthy recipes based on their purchase history. This additional feature not only promotes mindful consumption but also encourages users to explore new ways to utilize their fresh produce effectively. By embracing these recommendations, users can make informed choices, save money by purchasing only what they need, and foster healthier eating habits.

Using the application 200, users can locate nearby produce vending machines based on their location, browse available produce, view product details, and make their selections. The application 200 can communicate with the computing device 110 of the produce vending machine 102, initiating the process of dispensing a selected item. The application 200 may also keep track of user payment methods for smooth interaction with the produce vending machine 102. In a further aspect, especially if a user does not want to or is unable to physically touch the interfacing device 112, the user may be able to interact with the produce vending machine 102 to make their selections and pay through the application 200 by the user device 10.

FIG. 6A shows a first user interface 210 showing an example “home” page of the application 200, which can provide alerts on “produce expiring soon”, as well as present a “food inventory” and “recipe book”.

FIG. 6B shows a second user interface 220 showing an example “food inventory” page of the application 200. As shown, the application 200 may keep track of user food inventory held by the user including items, quantity, date of purchase/storage, and estimated remaining lifetime (e.g., window of time before spoilage). The application 200 may stratify freshness based on how long the items have been in storage, e.g., “Fresh”, “Good”, “Expiring Soon”, “Rotten”. The application 200 can generate a reminder notification for display at the user device 10 based on an estimated expiration date of a produce item relative to a current date. The server device 150 may also communicate information about a current stock of the produce vending machine 102 to the user through the application 200, which may be personalized based on preferences (food and/or location) and/or planned recipes of the user (e.g., “Strawberries are back!”, “Cherry Tomatoes are almost gone at ASU Memorial Union location!”, etc.),

In some examples, as shown in the third user interface 230 of FIG. 6C, the application 200 may display guidelines on how to best care for and store produce items to prolong freshness and reduce food waste. Guidelines may also be provided about how to best use imperfect food or food of varying freshness (e.g., overripe bananas may be used to make banana bread, etc.). Guidelines may be retrieved from the server device 150, which may be maintained based on food research and safety guidelines.

Further, as shown in the fourth user interface 240 featured in FIG. 6D, the application 200 may display recipes based on user food inventory, including recipes based on which produce items are expected to expire soon so that a user may be reminded to consume them. Recipes may be retrieved from the server device 150, which may be updated on a regular basis with trends and consumer feedback. Recipes may be prioritized for display through the application 200 at the user device 10 based on estimated expiration date, available food inventory, preferences (favorites, dislikes, allergies, dietary needs) of the user, “season” (e.g., strawberries being at their best and/or most abundant during a particular season), and/or past activity of the user. Additionally, when applicable, the application 200 may display important safety information about preparation of produce items, such as the importance of thoroughly rinsing leafy greens to avoid exposure to foodborne illness and thoroughly cooking potatoes to avoid toxic exposure. Further safety information provided by the application 200 can include information about how and when to best store leftovers, how to best reconstitute or use leftovers (including alternative recipes that can use leftovers), and how long before they spoil.

In some examples, the application 200 can receive meal plan input from a user, including selection or input of one or more planned recipes. Based on the planned recipes and the user food inventory, the application 200 can identify one or more missing produce items within the selected recipe with respect to the user food inventory and can notify the user. In some examples, the application 200 can generate a shopping list for display at the user device 10 that includes the one or more missing produce items, one or more “staple” items, one or more expired items, and/or one or more previously-purchased items. The user may also start the shopping list themselves, and can manually enter items for inclusion within the shopping list as well as prompt the application 200 to add in any missing items, favorite items, etc. Such an example is shown in a fifth user interface 250 shown in FIG. 6E.

In some embodiments, as shown in a sixth user interface 260 shown in FIG. 6F, the application 200 can pre-populate a selection input for communication to one or more of the server device 150 and the computing device 110 of the produce vending machine 102 based on the shopping list associated with the user (and intersection between the shopping list and available produce stored within the produce vending machine 102). The selection input may be captured or otherwise maintained at the user device 10, which can communicate, over a communication channel, the selection input to one or more of the server device 150 and the computing device 110 of the produce vending machine 102. In some examples, as illustrated in an seventh user interface 270 of FIG. 6G and as also shown in FIG. 2C, the user device 10 can communicate selection input(s) and/or payment information to the computing device 110 of the produce vending machine 102 through various modalities such as, but not limited to, near-field communication (NFC), Bluetooth, Wi-Fi, cellular (4G, 5G, LTE, etc.), scanning a Quick-Response (QR) code displayed on a screen of the user device 10, and the like. This may be particularly convenient when multiple selections are being made and for sanitary interaction with the produce vending machine 102.

In other examples, the user device 10 can communicate selection input(s) and/or payment information to the server device 150 which may be operable to access the selection input indicating the produce item, record the selection input from the user device 10 with respect to the produce vending machine 102, and communicate the selection input to the computing device 110 of the produce vending machine 102 over a network such as Wi-Fi or cellular (4G, 5G, LTE, etc.).

Further, as shown in an eighth user interface 280 of FIG. 6H, the server device 150 can communicate a location of the produce vending machine 102 to the user relative to a GPS location of the user device 10.

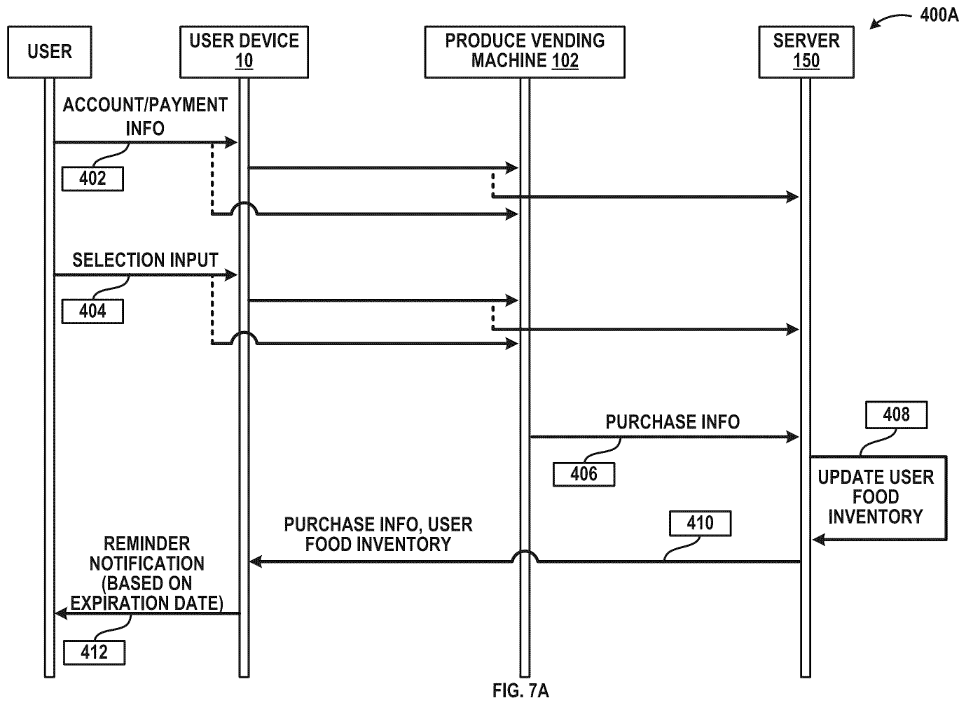

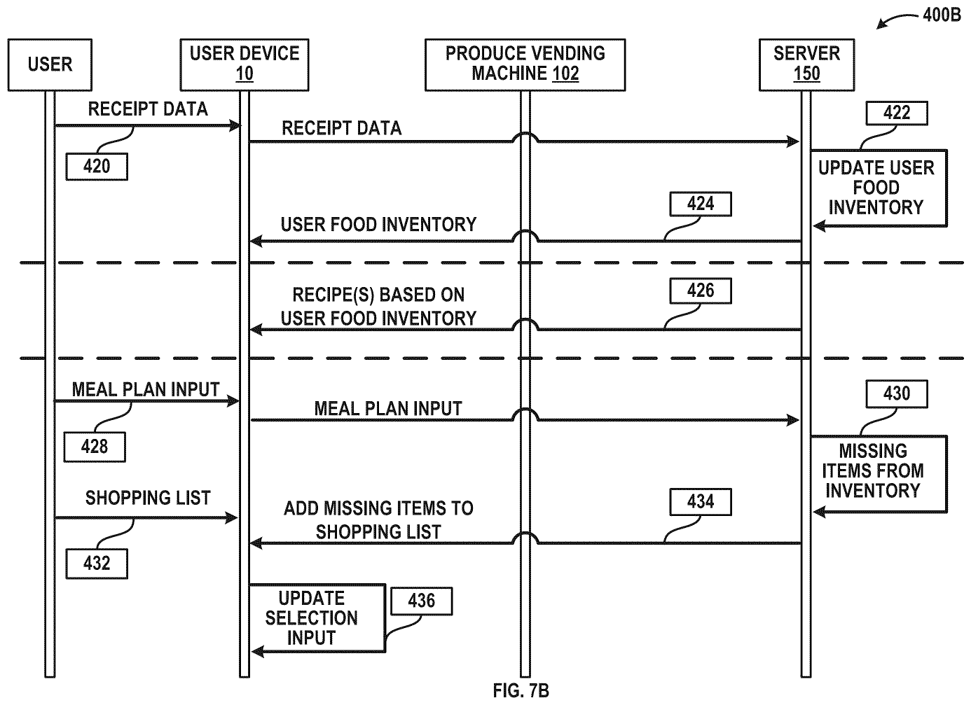

FIGS. 7A and 7B show example sequence diagrams outlining example interactions between a user, a user device 10, the produce vending machine 102 (specifically, the computing device 110 of the produce vending machine 102), and the server device 150. Note that while example interactions described in FIGS. 7A and 7B are discussed in terms of functionalities implemented by the user device 10, the produce vending machine 102, and the server device 150, the functionalities may be performed by any one of server device 150, produce vending machine 102, and user device 10 (for example, while server device 150 is shown as performing a step of determining missing items from a user food inventory held by the user, this step may alternatively be performed by the user device 10).

In a first sequence diagram 400A shown in FIG. 7A, at block 402 a user communicates account or payment information to the system. This may be completed by communicating payment information directly to the produce vending machine 102 as shown in FIG. 2A, e.g., by scanning a card. This may also be completed by communicating payment information to the user device 10 (e.g., by signing into a user account and linking a payment account to the user account). The user device 10 may communicate the account or payment information to the produce vending machine 102 over a network or through another modality such as an NFC channel or by scanning a QR code displayed at the user device 10. The user device 10 can also communicate the account or payment information to the server device 150.

At block 404, the user communicates selection input to the produce vending machine 102, which can be completed in a variety of ways. Similar to block 402, the user may communicate selection input directly to the produce vending machine 102 as shown in FIG. 2B. The user may also communicate selection input to the user device 10 which may be achieved by selecting one or more items through the application 200. The user device 10 may communicate the selection input to the produce vending machine 102 over a network or through another modality such as an NFC channel or by scanning a QR code displayed at the user device 10. The user device 10 can also communicate the selection input to the server device 150.

At block 406, following purchase, the produce vending machine 102 can communicate information about the purchase to the server device 150 which records information about the purchase in association with a user account. This can include, but is not limited to: information about what items were selected, weight displacement value(s) indicating weights of items purchased, monetary charges, which produce vending machine was visited, and estimated expiration dates for produce items.

At block 408, the server device 150 can establish and/or update a user food inventory associated with the user account based on the information about the purchase. At block 410, the server device 150 can communicate the information about the purchase as well as the user food inventory (which includes estimated expiration dates for produce items). At block 412, the user device 10 generates reminder notifications to the user based on the estimated expiration dates for the produce items, reminding the user to use the purchased items before they go to waste.

A second sequence diagram 400B shown in FIG. 7B shows various additional features that the application 200 may provide with respect to the user device 10 and the server device 150.

In some examples, at block 420, the user may communicate receipt data to the user device 10, e.g., by scanning a printed grocery receipt through a camera device or otherwise uploaded to the application 200 at the user device 10. The user may also communicate receipt data to the application 200 at the user device by linking a grocer or nutritional tracker app which may provide information about additional produce items held by the user which were not purchased through the produce vending machine 102. The user device 10 can communicate the receipt data to the server device 150. At block 422, the server device 150 updates the user food inventory based on the receipt data and at block 424 the server device 150 returns information about the updated user food inventory for display at the user device 10.

In a further example, at block 426, the server device 150 may communicate one or more recipes to the user device 10 which can be based on the user food inventory and/or other information about the user, such as past purchase or recipe information, dietary preferences of the user, and the like.

In some examples, at block 428, the user may communicate a meal plan input to the user device 10 (which can be, e.g., manually entered by the user, selected from a recipe list provided by the server device 150, uploaded with reference to a recipe website, etc.). The user device 10 can communicate the meal plan input to the server device 150. At block 430, the server device 150 can cross-reference the meal plan input with the user food inventory and identify one or more missing items. In other examples, the user device 10 may cross-reference the meal plan input with the user food inventory and identify one or more missing items rather than communicating with the server device 150.

At block 432 the user may communicate a shopping list to the user device 10. At block 434, the server device 150 (or the user device 10) can add the one or more missing items to the shopping list. In some examples, as shown in block 436, the user device 10 can update the selection input based on the shopping list.

The functions performed in the processes and methods may be implemented in differing order. Furthermore, the outlined steps and operations are provided as examples, and some of the steps and operations may be optional, combined into fewer steps and operations, or expanded into additional steps and operations without detracting from the essence of the disclosed embodiments.

### Computer-implemented System

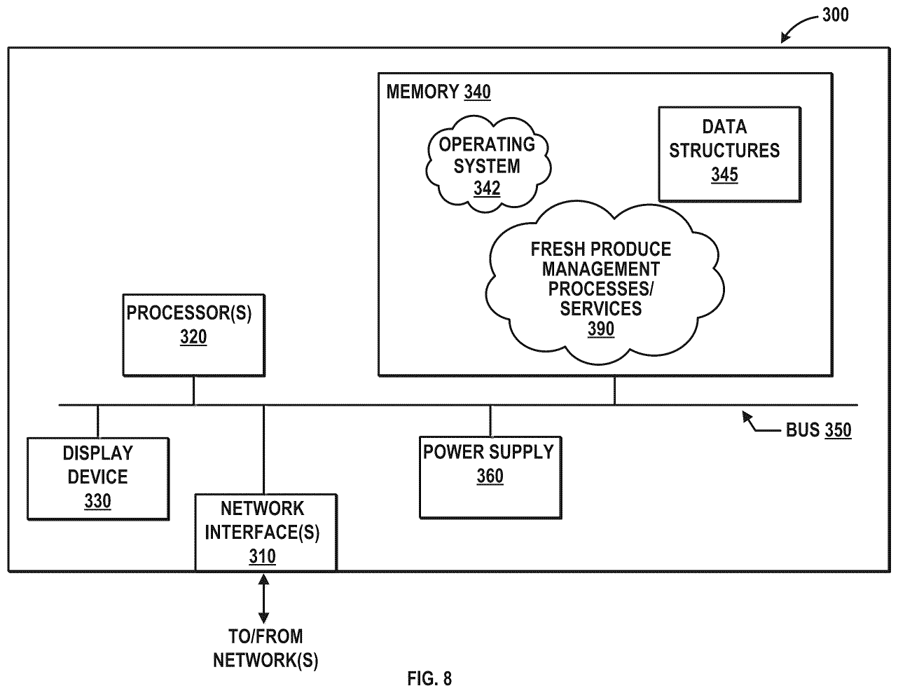

FIG. 8 is a schematic block diagram of an example computing device 300 that may be used with one or more embodiments described herein, e.g., as computing device 110 of produce vending machine 102, as user device 10, and/or as server device 150.

Computing device 300 comprises one or more network interfaces 310 (e.g., wired, wireless, PLC, etc.), at least one processor 320, and a memory 340 interconnected by a system bus 350, as well as a power supply 360 (e.g., battery, plug-in, etc.). Computing device 300 may also communicate with a display device 330 for displaying information, which can in some examples include the interfacing device 112 of the produce vending machine 102 or as a display of the user device 10.

Network interface(s) 310 include the mechanical, electrical, and signaling circuitry for communicating data over the communication links coupled to a communication network. Network interfaces 310 are configured to transmit and/or receive data using a variety of different communication protocols. As illustrated, the box representing network interfaces 310 is shown for simplicity, and it is appreciated that such interfaces may represent different types of network connections such as wireless and wired (physical) connections. Network interfaces 310 are shown separately from power supply 360, however it is appreciated that the interfaces that support PLC protocols may communicate through power supply 360 and/or may be an integral component coupled to power supply 360.

Memory 340 includes a plurality of storage locations that are addressable by processor 320 and network interfaces 310 for storing software programs and data structures associated with the embodiments described herein. In some embodiments, computing device 300 may have limited memory or no memory (e.g., no memory for storage other than for programs/processes operating on the device and associated caches). Memory 340 can include instructions executable by the processor 320 that, when executed by the processor 320, cause the processor 320 to implement aspects of the produce management system 100 and the methods outlined herein.

Processor 320 comprises hardware elements or logic adapted to execute the software programs (e.g., instructions) and manipulate data structures 345. An operating system 342, portions of which are typically resident in memory 340 and executed by the processor, functionally organizes computing device 300 by, inter alia, invoking operations in support of software processes and/or services executing on the device. These software processes and/or services may include fresh produce management processes/services 390, which can include aspects of the method and/or implementations of various modules described herein. Note that while fresh produce management processes/services 390 is illustrated in centralized memory 340, alternative embodiments provide for the process to be operated within the network interfaces 310, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the fresh produce management processes/services 390 is shown as a standalone process, those skilled in the art will appreciate that this process may be executed as a routine or module within other processes.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A system, comprising:
a produce vending machine including:
an outer protective structure having a retrieval door and a produce item captured within the outer protective structure; and
an actuation mechanism configured to retrieve the produce item responsive to a selection input from a user and position the produce item proximate the retrieval door; and
a server device including a first processor in communication with a first memory, the first memory including instructions executable by the first processor to:
record, at a data storage device associated with the server device, information about the produce item with respect to a user account associated with the user; and
communicate, over a network, the information to a user device of the user.

2. The system of claim 1, the user device including a second processor in communication with a second memory, the second memory including instructions executable by the second processor to:
capture the selection input from the user indicating the produce item; and
communicate, over a communication channel, the selection input to the server device or a computing device of the produce vending machine.

3. The system of claim 1, the first memory of the server device including instructions executable by the first processor to:
generate a user produce inventory associated with the user account, the user produce inventory including the information about the produce item and an estimated expiration date of the produce item; and
communicate, to the user device over the network, information about the user produce inventory including the estimated expiration date of the produce item.

4. The system of claim 3, the first memory of the server device including instructions executable by the first processor to:
communicate, to the user device and over the network, one or more recipes that include the produce item based on the user produce inventory.

5. The system of claim 4, the first memory of the server device including instructions executable by the first processor to:
display the one or more recipes based on the estimated expiration date of the produce item.

6. The system of claim 4, the first memory of the server device including instructions executable by the first processor to:
access a meal plan input from the user device that includes a selected recipe of the one or more recipes; and
generate a shopping list for display at the user device based on the selected recipe.

7. The system of claim 1, the user device including a second processor in communication with a second memory, the second memory including instructions executable by the second processor to:
access receipt data indicative of a grocery receipt associated with the user; and
communicate, to the server device over the network, information about one or more additional produce items identifiable within the receipt data for inclusion within a user produce inventory associated with the user account.

8. The system of claim 1, the user device including a second processor in communication with a second memory, the second memory including instructions executable by the second processor to:
generate a reminder notification based on an estimated expiration date of the produce item relative to a current date.

9. The system of claim 1, the produce vending machine including a computing device having a third processor in communication with a third memory, the third memory including instructions executable by the third processor to:
access the selection input indicating the produce item; and apply, based on the selection input, an actuating signal to the actuation mechanism that retrieves the produce item and positions the produce item proximate the retrieval door.

10. The system of claim 9, the produce vending machine including a near-field communication device in communication with the computing device, and the third memory including instructions executable by the third processor to:
access the selection input indicating the produce item from the user device through the near-field communication device proximate the user device.

11. The system of claim 9, the produce vending machine including a near-field communication device in communication with the computing device, and the third memory including instructions executable by the third processor to:
capture payment information from a user payment device through the near-field communication device proximate the user payment device.

12. The system of claim 1, the first memory of the server device including instructions executable by the first processor to:
record the selection input from the user device with respect to the produce vending machine; and
communicate the selection input to a computing device of the produce vending machine.

13. The system of claim 1, the first memory of the server device further including instructions executable by the first processor to:
apply a charge to a payment account associated with the user account based on the selection input.

14. The system of claim 1, the produce vending machine having a computing device including a third processor in communication with a third memory, the third memory including instructions executable by the third processor to:
calculate a weight displacement value based on a pre-selection weight and a post-selection weight of a produce container associated with the produce item; and
communicate information about the weight displacement value to the server device over the network, the server device being operable to apply a charge to a user payment account based on the weight displacement value.

15. The system of claim 1, the produce vending machine having an environment control system in communication with a computing device including a third processor in communication with a third memory, the third memory including instructions executable by the third processor to:
measure, by one or more sensors of the environment control system, one or more environmental condition values indicative of an environmental condition of an interior of the produce vending machine; and
apply a modifying input to an environmental control device based on the one or more environmental condition values.

16. The system of claim 1, the actuation mechanism of the produce vending machine being operable to actuate a produce container capturing the produce item from a storage position to a retrieval position responsive to an actuating signal.

17. The system of claim 1, the actuation mechanism of the produce vending machine having a claw element that carries the produce item from a storage position to a retrieval position responsive to an actuating signal.

18. The system of claim 1, the produce vending machine having an environment control system including one or more sterilization elements and/or one or more pest control elements.

19. The system of claim 1, the produce vending machine including a produce container having a grated surface that supports the produce item captured therein to circulate air below the produce item.

20. The system of claim 1, the produce vending machine including a growing tray.
